(19) United States
(12) Patent Application Publication
(10) Pub. No.: US 2008/0065662 A1
(43) Pub. Date: Mar. 13, 2008

(54) System and method for compressed tag codes and code mapping

(75) Inventors: Linda P. Stewart, Morgan Hill, CA (US); Roger G. Stewart, Morgan Hill, CA (US)

Correspondence Address: Zilka-Kotab, PC, P.O. BOX 721120, SAN JOSE, CA, 95172-1120, US

(73) Assignee: ALIEN TECHNOLOGY CORP.

(21) Appl. No.: 10/140,557

(22) Filed: May 7, 2002

Related U.S. Application Data
(60) Provisional application No. 60/294,951, filed on May 31, 2001.

(51) Int. Cl. G06F 7/00

(52) U.S. Cl. 707/101

(57) ABSTRACT

The invention according to one embodiment is a method of distributing information in an RFID tag code that allows a decrease in the tag code length and, at the same time, retains all the information required by longer hierarchical code specifications, such as the ePC code and G-tag code specifications. In another embodiment, the invention is a method of mapping information from a shorter tag code to a longer computer searchable hierarchical code with full data compatibility of the tag code data with the hierarchical code fields. In a further embodiment, the invention is a method of mapping a hierarchical code to a shorter tag code without loss of any information. Blocks in the domain space are sold to encourage judicious use of the space and to avoid wasting the space. Although it is desirable for a manufacturer to purchase domain space blocks that are contiguous in the domain space, the system disclosed is sufficiently flexible to accommodate manufactures of various sizes, as well as manufacturers whose needs change over time.

### RELATED APPLICATIONS

This application claims priority from U.S. Provisional Patent Application entitled “Compressed Tag Codes and Mapping,” filed on May 31, 2001 under Ser. No. 60/294,951, and which is herein incorporated by reference in its entirety.

### FIELD OF THE INVENTION

The present invention relates to RFID hierarchical codes, and more particularly, this invention relates to compression of tag codes and tag code mapping.

### BACKGROUND OF THE INVENTION

Bar codes are widely used to label products with information regarding the source of origin (the manufacturer) and the type of product (a box of cereal or a box of cereal of a certain size).

There are a number of proposed codes that aim to add a serial field to the bar code scheme. A serial field would enable a manufacturer to not only identify the source of origin and product type on a tag but to also identify the specific item. For example, such a tag, embedded in an automobile or in various parts of an automobile can be used to track the origin of the automobile or a specific part. Such information could be useful in determining if the automobile is stolen and who is the rightful owner.

In particular, these tags can be made to operate at various radio frequencies—so called RFID tags. Furthermore, such tags can be permanently embedded such that they cannot be removed from a product.

RFID tags can be detected from a distance. The ability to detect such a tag from a distance provides a number of advantages. RFID tags can be used to identify a given product precisely and to locate a specific product. For example, an RFID tag can identify a product as the one that was stolen from a store or to locate a product that is in a store but misfiled or misplaced.

Since the time required to read an RFID code increases as the length of the code increases, it is desirable to decrease the length of the tag code as much as possible. However, longer hierarchical codes, such as the proposed 96 bit ePC code, are required if manufacturers wish to track a specific item. Furthermore, these hierarchical codes are organized into hierarchical fields in order to be searchable by computer.

It would therefore be desirable to reduce the length of an RFID code while providing the benefits of the longer RFID codes containing such things as serial numbers.

It would also be desirable to provide a flexible system that is able to grow with a manufacturer's product line. Manufacturers share domain space but do not have the same identification numbers, so some codes may be assigned to one entity while other codes are assigned to another entity. Current bar codes have 2 levels. One is a manufacturer field that identifies the manufacturer. The second is a product description field, which describes the type of product, such as a 12 oz plastic jar of mayonnaise. In the new longer electronic codes, a third field is provided for the serial number, allowing identification of the particular item.

The problem is that different manufacturers may have different needs. Some may sell a few each of many types of products, thus requiring a product description field. Others may have a small product line but huge volume of those few products, thus requiring a larger serial number field. Thus, it may be difficult to determine how many of a particular type of codes an entity will need as its product line changes.

In all existing systems, if a manufacturer runs out of codes, a problem arises. Adding additional blocks of codes corrupts the whole domain space, as the hierarchical search for the code is incapable of being performed out of order.

What is needed is a way to assign fields in tag code space without the requirement that the assignments be contiguous. This would allow a manufacturer to purchase new blocks as needed.

### DISCLOSURE OF THE INVENTION

The invention discloses a 64 bit domain space that is less expensive and faster to use than a longer hierarchical code, that efficiently retains the same data as a longer hierarchical code, and that is comparable in performance to a longer hierarchical field. Furthermore, although the use of this invention is described in relation to the 96-bit ePC code, the invention supports compatibility with other RFID hierarchical code standards such as G-Tag.

The invention according to one embodiment is a method of distributing information in an RFID tag code that allows a decrease in the tag code length and, at the same time, retains all the information required by longer hierarchical code specifications, such as the ePC Code and G-tag code specifications. In another embodiment, the invention is a method of mapping information from a shorter tag code to a longer computer searchable hierarchical code with full data compatibility of the tag code data with the hierarchical code fields. In a further embodiment, the invention is a method of mapping a hierarchical code to a shorter tag code without loss of any information.

Blocks in the domain space are sold to encourage judicious use of the space and to avoid wasting the space. Although it is desirable for a manufacturer to purchase domain space blocks that are contiguous in the domain space, the system disclosed is sufficiently flexible to remap noncontiguous blocks of tag code space into an orderly semi-contiguous space in the hierarchical code space as well as to accommodate manufactures of various sizes, as well as manufacturers whose needs change over time. The system is also sufficiently flexible to accommodate manufacturers with varying product to serial mix ratios. For example, one manufacturer may sell an enormous quantity of a single product and another manufacturer may sell only a few items of each of thousands of products.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 depicts an RFID system according to one embodiment.

FIG. 2 is a schematic of a domain space of the invention.

FIG. 3 is a schematic of a tag and reader of the invention.

FIG. 4 is a schematic comparing the mapping command of the invention to the proposed ePC Code scheme.

FIG. 5 is a schematic illustrating a mapping scheme of the invention.

FIG. 6 illustrates mapping from a 64 bit tag code to a 96 bit ePC code.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The invention according to one embodiment is a method of distributing information in an RFID tag code that allows a decrease in the tag code length and, at the same time, retains all the information required by longer hierarchical code specifications, such as the ePC code and G-tag code specifications. In another embodiment, the invention is a method of mapping information from a shorter tag code to a longer computer searchable hierarchical code with full data compatibility of the tag code data with the hierarchical code fields. In a further embodiment, the invention is a method of mapping a hierarchical code to a shorter tag code without loss of any information.

The invention supports many types of RF tags. Although the needs of different applications and cost requirements may be met by one type of tag and not another, the different types of tags work together seamlessly. All tag types also may include a standardized wired I/O interface to sensors, clocks, displays and other devices.

Four illustrative types of tags are classified as follows:
Type 1 is a passive tag with simple 64-bit tag codes linked to 96-bit ePC codes.

Type 1 tags tend to be low cost. The type 1 tag code may be either all wafer-level programmed ROM or a hybrid ROM +36-bit EEPROM combination.

Type 2 is a passive tag with up to 65 Kbytes of embedded ROM and/or EEPROM. Some class-2 tags will be compatible with the 128-bit & 256 -bit G-tag specification.

Type 3 is a semi-passive tag with up to 65 Kbytes of embedded ROM and/or EEPROM and a built-in battery or other energy source to support increased read range and other functions. Type 4 is a “modem-like” active tag that can communicate with each other and/or other devices.

Other types of tags may also be supported by the invention. In fact, the system herein disclosed is intended for use with a number of international and proprietary codes and is hence generic and nearly universal.

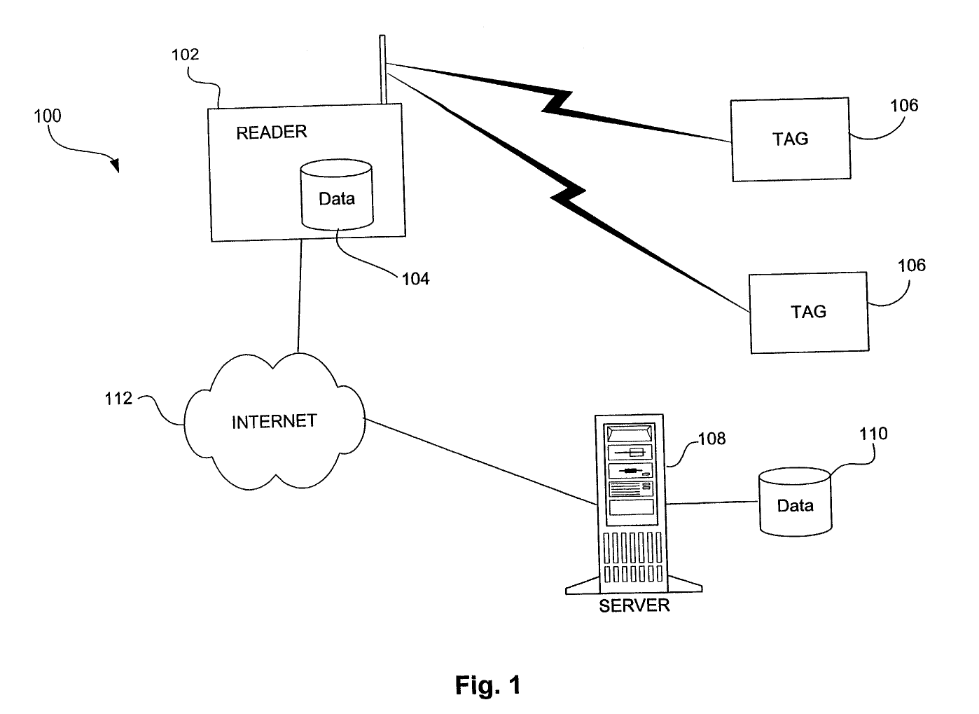

FIG. 1 depicts an illustrative RFID system 100 according to one embodiment. As shown, the system includes three components: a reader 102 having an antenna, a transceiver, and a database 104; one or more transponders 106 (the tags); and a remote server 108 coupled to or having a second database 110.

The antenna uses radio frequency waves to transmit a signal that activates a tag 106. When activated, the tag 106 transmits data back to the antenna. High and low-frequency systems may be used in any of the embodiments described herein. Illustrative low-frequency RFID systems (30 KHz to 16 MHz) have short transmission ranges (generally less than six feet). Illustrative high-frequency RFID systems (850 MHz to 950 MHz and 2.4 GHz to 2.5 GHz) offer longer transmission ranges (more than 90 feet). The reader 102 communicates with the server 108 via a wide area network 112 such as the Internet.

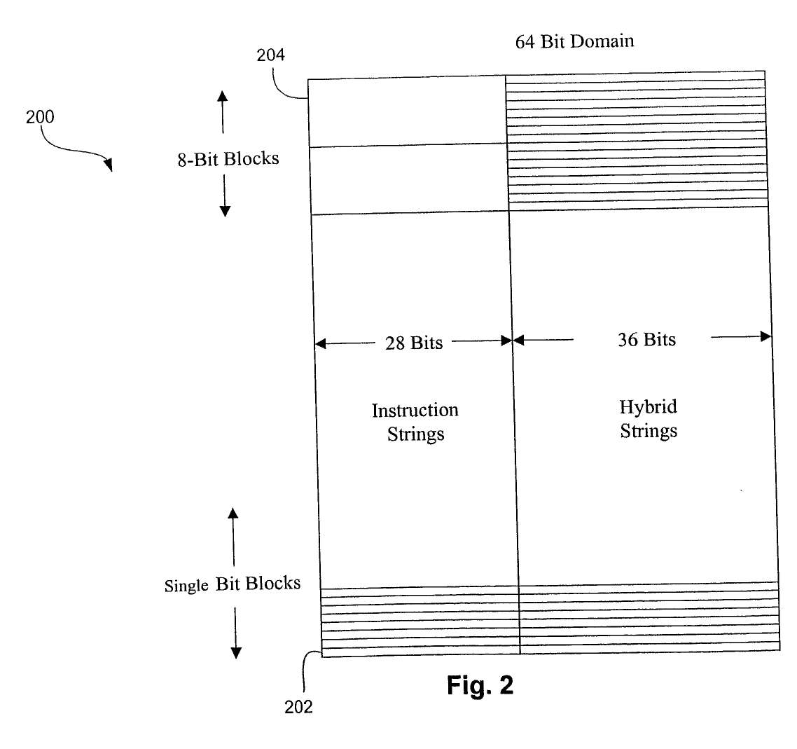

The schematic in FIG. 2 illustrates an illustrative domain space 100 of the present invention. The domain space 200 in FIG. 2 is a 64 bit domain consisting of 2̂²⁸ (260 million) small blocks of code. Each line of code comprises a 28 bit instruction string and a 36 bit hybrid string. Note that although embodiments of the invention are described in relation to a 64-bit domain, one skilled in the art will appreciate that domains of other sizes could be used as well, and that the teachings herein can be adapted for such domains without undue experimentation.

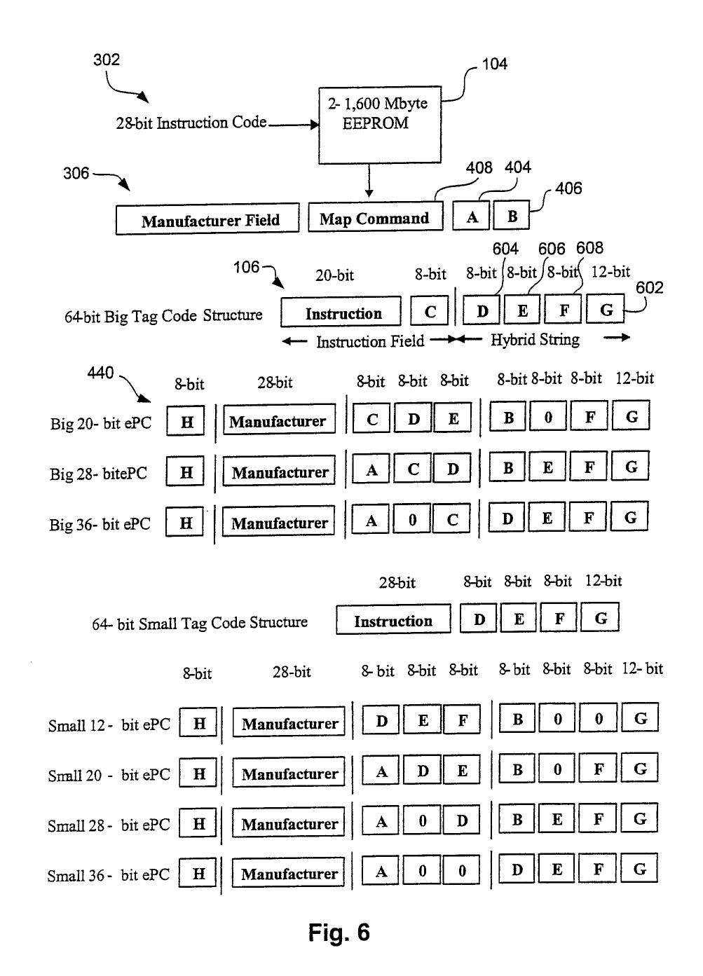

The domain space 200 can be divided into small blocks (i.e. 32-bit hybrid strings) 202 and large blocks (i.e. 44-bit hybrid strings) 204, as an example. Each of the lines in a small block 202 has the same instruction string. A large block contains 256 sequential instruction strings, with each line of those 256 instruction strings containing one of 2̂³⁶ (70 billion) hybrid strings (a total of 17 trillion tag codes). One can view an 8-bit block as a grouping of 256 sequential small blocks. It is convenient to parse each instruction string in an 8-bit block into a 20 bit instruction and an 8 bit address or extender. This extender is also referred to as field extender C (see FIG. 6).

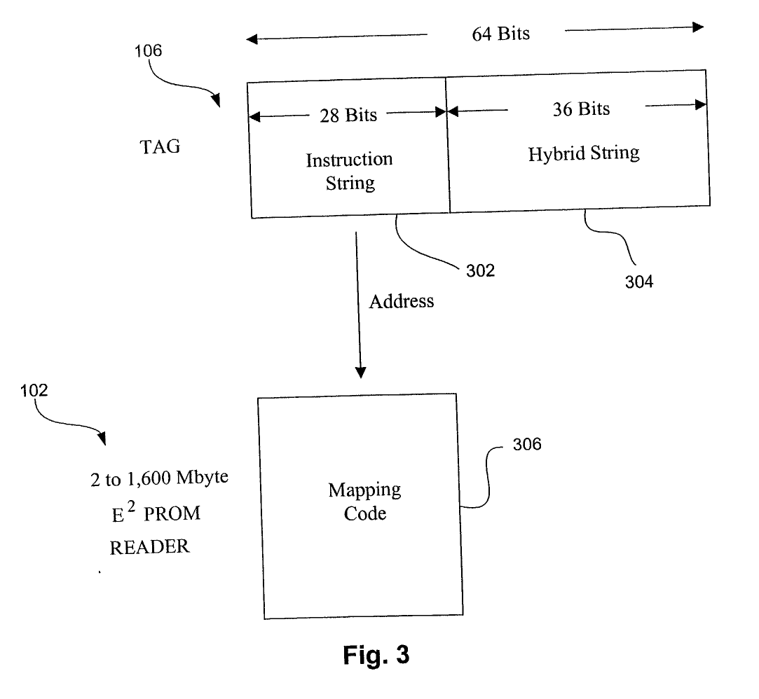

FIG. 3 illustrates a tag 106 comprising a 28 bit instruction string 302 and a 36 bit hybrid string 304. Each tag 106 corresponds to a different line of code in the domain space 200 of FIG. 2. It is possible to have 2̂³⁶ (70 billion) different tags 106 for each instruction string 302.

Also illustrated in FIG. 3 is that the tag instruction string 302 identifies an address in a reader 102. The reader 102 uses the address (instruction string) from a tag 106 to fetch the corresponding mapping code 306 from a database. That database may reside in any accessible location, such as, for example, in the reader 102, a local or remote computer, or on the Internet.

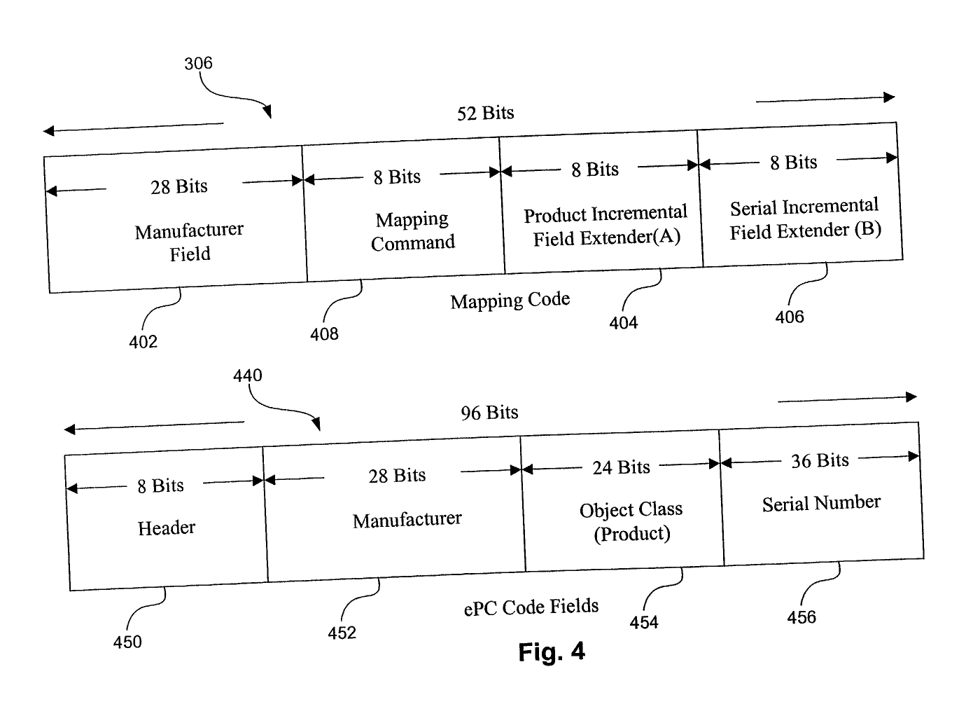

FIG. 4 illustrates the mapping code 306 corresponding to each instruction string. The mapping code 306 contains a manufacturer field 402, product incremental and serial incremental field extenders 404, 406 and a mapping command 408 or command. The product incremental field extender 404 is also referred to as field extender A and the serial incremental field extender 406 is also referred to as field extender B. Several different instruction strings 302 may correspond to the same manufacturer.

Also illustrated in FIG. 4 is a proposed set of fields for the ePC code 440. As shown, the 96-bit ePC code is formatted as follows: 8-bit header 450, 28-bit manufacturer field 452, 24-bit product field 454, and 36-bit serial number 456.

Mapping

The reader communicates with a tag that is encoded with a re-mapped and compressed 64-bit tag code that is derived from the fields of the 96-bit ePC code (8-bit Header, 28-bit manufacturer, 24-bit product, 36-bit serial), the 128-bit ePC code, the 256-bit ePC code or the 128-bit or 256 -bit G-tag codes. The mapping back and forth between the 96-bit ePC code and the 64-bit compressed tag code is shown in FIG. 6.

Each reader or group of readers has a memory driven “mapper” to either expand the 64-bit tag code into the fields of a 96-bit ePC code (or other code) or to compress the fields of 96-bit codes (or other codes) back into 64-bit tag codes.

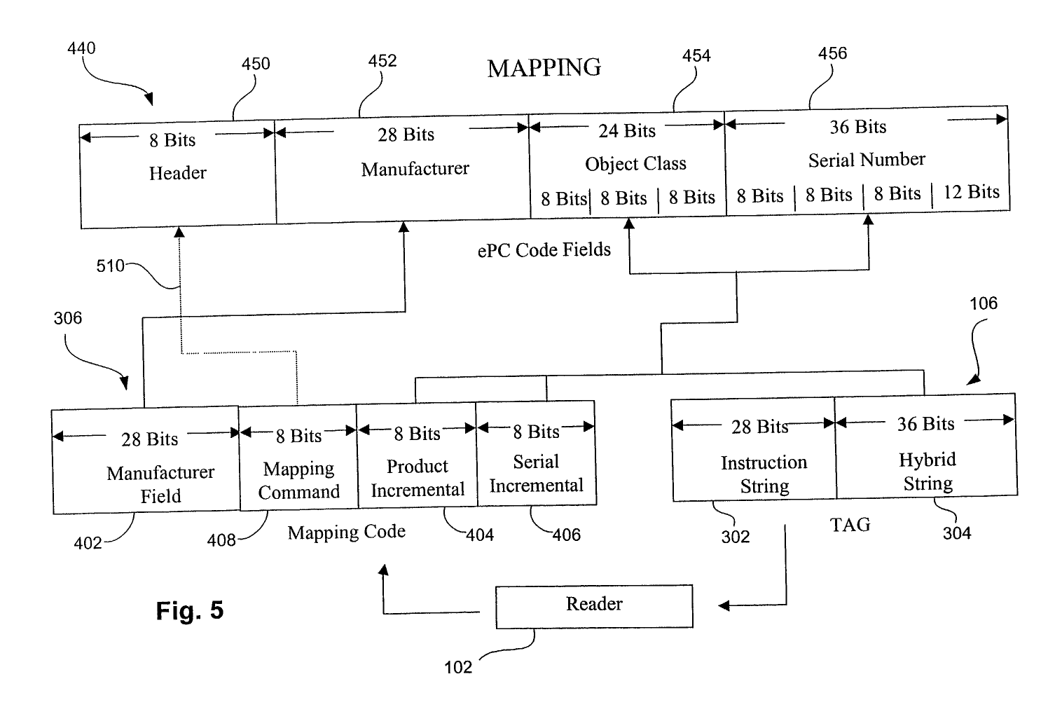

FIG. 5 illustrates a scheme used to map a tag 106 with a fewer number of bits into a hierarchical code with a greater number of bits, utilizing the proposed 96 bit ePC code 440 as an example of a hierarchical code.

Referring to FIG. 5, a reader 102 obtains an instruction string 302 from a tag 106 and uses that instruction string 302 as an address to fetch the corresponding mapping code 306 from a database. The database may reside in the reader 102 or in any suitable location accessible to the reader 102. The database is preferably updated regularly. Typically, as space in the domain 200 is allocated or sold, a central database is updated to reflect the addition of new data. An advantage of locating the database that is accessible to the reader 102 on the Internet is that the information accessible to the user is then the most current information available, since the database available through the Internet can be the same central database that is updated as changes occur, that is, in real time. The data may be downloaded from a central database and stored, for example in a 2 to 1,600 megabyte EEPROM or other suitable memory or storage device.

The mapping code 306 comprises a manufacturer field 402 that is the same as the manufacturer field 452 in the greater bit code (the ePC code in the illustration), two optional incremental fields 404, 406, and a mapping command 408. The mapping command 408 is used to map the manufacturer field 402, field extender A 404 and field extender B 406 from the mapping command 408, and field extender C and the bits of the hybrid string 304 from the tag 106 to fields 452, 454, 456 in the hierarchical code 440.

The incremental field extenders 404, 406 permit a manufacturer to use more than one instruction string 302 and to allocate bits of the hybrid string 304 for mapping to a product field 454 or a serial field 456 in accordance with the needs of the particular manufacturer. For example, if a manufacturer is allowed to use two different Instruction fields 302 such as 000 . . . 0001 and 000 . . . 110, the two Instruction fields 302 will correspond to the same manufacturer field 402 but will have different data fields, such as, for example, 00000000 and 00000001.

In this example, the number of mapping commands 408 is limited to 256. Seven of these mapping commands 408 are used to map to and from a 64 bit tag 106 and the 96 bit ePC code 440. Other mapping commands 408 can be used for mapping between a 64 bit tag 106 and other hierarchical codes, such as a 128 bit G-tag code or a 128 bit ePC code.

FIG. 6 illustrates the mapping of tag and mapping command bits to and from hierarchical code fields under the direction of seven different mapping commands. In particular, this example depicts mapping between a 64 bit tag code and a 96 bit ePC hierarchical code. Each of the 256 possible mapping commands is used to map to and from only one specific hierarchical code. For example, the seven commands used in the illustration are specific for a 96-bit ePC code 440. Each hierarchical code has a unique header. Accordingly, the mapping command also determines the header in the hierarchical code. This is illustrated by the dotted arrow 510 in FIG. 5.

FIG. 6 also illustrates that the hybrid string 304 of the tag 106 is sub-divided into a 12-bit serial field (serial field “G”) 602 plus three 8-bit field extenders (field extenders “D”, “E”, and “F”) 604, 606, 608. The 96 bit ePC hierarchical code 440 contains an 8 bit header, a 28 bit manufacturer field, a 24 bit product field, and a 36 bit serial field. The 24 bit product field is divided into three 8 bit fields and the 36 bit serial field is divided into three 8 bit fields and a 12 bit field.

The mapping illustrated in FIG. 6 is for the following 96 bit ePC code mapping commands:

Big Block Mapping Commands:
Big 20-bit Serial
Big 28-bit Serial
Big 36-bit Serial

Small Block Mapping Commands:
Small 12-bit Serial
Small 20-bit Serial
Small 28-bit Serial
Small 36-bit Serial

In the Big tag code structure, the 28 bit instruction string comprises a 20 bit instruction and an 8 bit extender (field extender C).

A reader uses the instruction string of a tag as a database address to fetch a corresponding mapping code 306. The mapping code contains a 28 bit manufacturer field that is the same as the 28 bit manufacturer field of the 96 bit ePC code, a mapping command that is recognized as corresponding to a 96 bit ePC code and hence determines the header of the 96 bit ePC code, an 8 bit product incremental field extender (field extender A) and an 8 bit serial incremental field extender (field extender B).

In mapping from a 64 bit tag code to a 96 bit ePC code, the preferred minimum ePC serial field is twelve bits long, which is achieved by mapping field G from the hybrid string into the 12 bit field of the serial field of the 96 bit ePC code. As illustrated in FIG. 6, the ePC serial field can be incrementally expanded by sequentially mapping field extenders F (to expand to up to 20 bits), E (for expansion to up to 28 bits), and D (for expansion to 36 bits). Expansion of the serial field to 44 bits or 52 bits can be achieved but would require a field code even longer than 96-bit basic ePC code. In some cases, this would involve non-contiguous blocks within the 64-bit tag code that are mapped semi-contiguously into the same hierarchical code space in the ePC code. In this semi-contiguously space, there may be unused codes or “gaps” within such hierarchical and otherwise contiguous code space.

As illustrated in FIG. 6, in mapping from a 64 bit tag code to a 96 bit ePC code, the ePC product field can also be incrementally expanded by sequentially mapping field extenders D (to expand to up to 8 bits), E (for expansion to up to 16 bits), and F (for expansion to 24 bits). Expansion of the product field to 32 bits, 40 bits, or 48 bits can be achieved but would require a hierarchical code even longer than the 96-bit ePC code. In some cases, this would involve non-contiguous blocks within the 64-bit tag code that are mapped into the same hierarchical code space in the ePC code. There may be unused codes or “gaps” within such hierarchical and otherwise contiguous code space.

When a manufacturer has the right to use more than one instruction string, incremental field extender B is used to augment the number of possible serial field combinations in the ePC code and incremental field extender A is used to augment the number of possible product field combinations in the ePC code.

Note that the mapping of this invention can be used in a system in which all readers interface to the system using either the 96-bit ePC code or the 128-bit G-tag code. The invention also supports the future use of 128-bit ePC codes, 256 -bit ePC codes, and 256 -bit G-tag codes, and other international and proprietary codes.

Domain Space Allocation

The mapper described above allows allocation of individual blocks in the tag code space. The 64-bit tag codes are assigned in a sequential contiguous manner but may contain non-contiguous blocks of codes that were assigned to the same manufacturer at different times. In order to be compatible with the field codes, these non-contiguous tag code blocks must be mapped into the fields of hierarchical codes before performing any web-based search operations. In tag code space, the assignments do not need to be contiguous. When mapped into the hierarchical field code space, the blocks become contiguous or at least semi-contiguous (i.e. there may be unused codes or “gaps” within such hierarchical and otherwise contiguous code space).

Preferably, an 8-bit prefix “11111111” triggers that this information will be read as an 8-bit Branch Header, and is used to branch to an alternate domain space.

In one embodiment, up to 1,000,000 “large 44-bit manufacturing blocks” are assigned in descending order based on their dates of assignment. Multiple assignments to the same manufacturer are allowed and may be made at different times resulting in non-contiguous tag code assignments to a single manufacturer. However, the 256 Instruction codes within each large manufacturing block must be in a single contiguous block and an 8-bit code corresponding to each of these 256 one-bit blocks of Instruction codes will be mapped into a field of an ePC code as field extender “C”.

Up to 255,000,000 “small 36-bit manufacturing blocks” are assigned in ascending order. Multiple assignments to the same manufacturer are allowed and may be made at different times resulting in non-contiguous tag code assignments to a single manufacturer

Up to 256 large or small blocks may be assigned to a single manufacturer if needed.

Within each small block, three 8-bit Extender Blocks of addresses may be assigned (under control of the mapping command) to either the ePC product field or the ePC serial field depending on the needs of that particular manufacturer.

The mapper may contain an EEPROM memory with up to a 28-bit memory address. 52 bits of data are stored at each memory location including: a 28-bit manufacturer field, an 8-bit mapping command, an 8-bit product incremental field extender (field extender “A”), and an 8-bit serial incremental field extender (field extender “B”).

A different 8-bit mapping command may be assigned to each of the 260 million 28-bit prefixes (instruction fields). This information is stored in the reader EEPROM or other location accessible to the reader and is updated regularly.

The 28-bit instruction string is used in the EEPROM to map between non-contiguous code blocks in the 64-bit tag code space and the hierarchical and contiguous code blocks required by the 96-bit ePC code world-wide-web protocol.

To map back easily from the 96-bit field code to the 64-bit tag code, the 28-bit instruction string, and the 8-bit mapping command are appended to the 96-bit hierarchical code (increasing its total length to 132 bits).

A 28-bit tag code instruction string supports up to 268,435,456 separate manufacturers. However, since domain needs will vary greatly from one manufacturer to another, up to 16,777,216 instruction strings can be assigned to a single manufacturer if needed. Even though these instruction strings may be non-contiguous in the tag code space, the instruction strings are used to fetch a corresponding mapping code that includes a 28-bit manufacturer field that is then mapped into the 28-bit manufacturer field in the 96-bit ePC code. The hybrid extender fields are flexibly allocated by the manufacturer between product fields and serial fields as described above with variable mixtures of short and long serial fields to meet the needs of even the largest multi-national manufacturers. Since a manufacturer is not required to actually use every code assigned, there may be unused codes or “gaps” within the contiguous domain code space.

In order to discourage wasting of the domain space, it is preferable that a manufacturer purchases the blocks it needs and that the pricing be such that a manufacturer is discouraged from purchasing blocks that it does not need.

In meeting these objectives, the domain space is preferably divided into small blocks and large 8-bit blocks, as shown in FIG. 2. A sufficient number of 8-bit blocks, for example 1,000,000, are available for sale to large manufacturers. The 8 bit blocks are given addresses and are sold sequentially starting at one end of the domain space. And, the small blocks are given addresses and sold sequentially starting at the other end of the domain space.

The domain fee per tag is smaller than the tag cost, which is, in turn, much smaller than the total available domain space cost. The small blocks are sold for a reasonable price, for example $1,000. And, the 8-bit blocks are sold at a discounted price relative to the purchase of the equivalent space in 256 small blocks, for example $100,000.

Manufacturers are encouraged to purchase the number and size of blocks sufficient for their needs. However, the system recognizes that the needs of a manufacturer may change over the course of time. Accordingly, a manufacturer may purchase additional small and/or large blocks when needed, up to a total of the equivalent of 65,000 small blocks.

Simple calculations show that the means of purchase allocation disclosed in this invention would cost no more than $1,000 for 70 billion tags or 687,194 tags for a single penny. At the same time the cost of purchasing the entire domain space would cost at least $104,857,600,000 and as much as $268,435,456,000. Accordingly, the fees are not burdensome for any legitimate use of the codes by a manufacturer. At the same time, if someone were to attempt to abuse or control the domain space, the cost should be prohibitive.

Note that blocks may also be sold at a flat fee per block.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for bi-directional mapping of a tag code into a hierarchical code, comprising:
obtaining an instruction string from an RFID tag;
finding a mapping code in a database using the instruction string;
retrieving the mapping code from the database, the mapping code including a mapping command and at least one field corresponding to a hierarchical code;
retrieving a plurality of bits from the tag; and
using the mapping command to map the fields of the mapping code and the plurality of bits of the tag into fields in the hierarchical code.

2. The method as recited in claim 1, wherein one field of the mapping code is a manufacturer field.

3. The method as recited in claim 1, wherein one field of the mapping code is an incremental field extender, wherein the incremental field extender permits use of more than one instruction string.

4. The method as recited in claim 1, wherein one field of the mapping code is an incremental field extender, wherein the incremental field extender permits allocation of bits of the hybrid string for mapping to a particular field of the hierarchical code.

5. The method as recited in claim 4, wherein at least a portion of the plurality of bits of the tag is allocated between a product field and a serial field.

6. The method as recited in claim 1, wherein the database is stored in a tag reader.

7. The method as recited in claim 1, wherein the database is stored in a remote computing device accessible via the Internet.

8. The method as recited in claim 1, wherein additional mapping information is appended to the at lest one field of the hierarchical code.

9. The method as recited in claim 8, wherein the additional mapping information is the instruction string and the mapping command.

10. The method as recited in claim 1, wherein the hierarchical code contains a greater number of bits than the tag code.

11. The method as recited in claim 1, wherein the plurality of bits of the tag code is a hybrid string.

12. A method for mapping a generic RFID tag code to multiple fields of a multiplicity of different types of hierarchical codes, comprising:
identifying an instruction string of an RFID tag code, the instruction string having database address information;
identifying additional bits in the tag code;
selecting a hierarchical code to map the tag code to;
mapping the additional bits to field of the hierarchical code;
generating a mapping code having the mapping of the additional bits to fields of the hierarchical code; and
associating the mapping code with the address information of the tag code instruction string.

13. The method as recited in claim 12, wherein the hierarchical code has more bits than the tag code.

14. The method as recited in claim 12, further comprising storing the mapping code according to the address information.

15. A method for generating an instruction code, comprising:
generating an instruction code identifying a mapping code; and
embedding the instruction code in an RFID tag code.

16. The method as recited in claim 15, wherein the mapping code includes a manufacturing code, a mapping command, and at least one incremental field extender.

17. A method for generating a tag code, comprising:
generating a tag code identifying database information; and
embedding the tag code in an RFID tag.

18. The method as recited in claim 17, wherein the tag code includes instruction code.

19. The method as recited in claim 17, wherein the database information includes mapping code.

20. The method as recited in claim 17, wherein the database information includes manufacturing information.

21. The method as recited in claim 17, wherein the database information includes product identification information.

22. A tag code for identifying database information; where the tag code is embedded in an RFID tag.

23. A hierarchical code including information to facilitate compression thereof.

24. The hierarchical code as recited in claim 23, wherein the information is appended to the hierarchical code.

25. The hierarchical code as recited in claim 23, wherein the information is an instruction code.

26. A method for retrieving manufacturing codes on a wide area network, comprising:
retrieving an instruction string from an RFID tag;
identifying an address of a manufacturing code using the instruction string, the manufacturing code being stored in memory accessible via a wide area network; and
retrieving the manufacturing code from the memory via the wide area network.

27. The method as recited in claim 26, wherein the wide area network is the Internet.

28. A method for assigning multiple non-contiguous domain code blocks into an ordered field, comprising:
assigning a first block of an RFID-related domain space to a single party;
assigning a second block of the domain space to the party;
wherein the blocks are not contiguous; and
mapping each block to a same ordered field code space.

29. The method as recited in claim 28, wherein the ordered field space is a hierarchical field space.

30. A method for selling domain space, comprising:
charging a domain fee based on a number of RFID tag codes;
wherein the domain fee is less than a cost of a tag;
wherein the annual cost of all tags is less than a cost of all available domain space.

31. The method as recited in claim 30, wherein large blocks of the domain are sold at a discount relative to the cost of purchasing individual small blocks in an equivalent amount of the domain.

32. A method for selling domain space, comprising;
charging a fee for RFID tag code domain space based on a number of domain code blocks purchased.

33. A method for assigning multiple non-contiguous domain address blocks to a single manufacturer, comprising:
assigning a first address block of an RFID-related domain space to a single party;
assigning a second address block of the domain space to the party;
wherein the address blocks are not contiguous; and mapping each address block to a same ordered manufacturer field code space.

34. A system for bi-directional mapping of a tag code into a hierarchical code; comprising:
logic for obtaining an instruction string from an RFID tag;
logic for finding a mapping code in a database using the instruction string;
logic for retrieving the mapping code from the database, the mapping code including a mapping command and at least one field corresponding to a hierarchical code;
logic for retrieving a plurality of bits from the tag; and
logic for using the mapping command to map the fields of the mapping code and the plurality of bits of the tag into fields in the hierarchical code.

35. The method as recited in claim 34, wherein the hierarchical code has more bits than the tag code.

36. A computer program product for bi-directional mapping of a tag code into a hierarchical code, comprising:
computer code for obtaining an instruction string from an RFID tag;
computer code for finding a mapping code in a database using the instruction string;
computer code for retrieving the mapping code from the database, the mapping code including a mapping command;
computer code for retrieving a plurality of bits from the tag; and
computer code for using the mapping command to map the fields of the mapping code and the plurality of bits of the tag into fields in the hierarchical code.

37. The computer program product as recited in claim 36, wherein the mapping code includes at least one field corresponding to a hierarchical code.

38. A method, comprising mapping a generic RFID tag code to multiple fields of a hierarchical code, wherein the generic tag code includes an instruction code.

39. A system for generating an instruction code, comprising:
an instruction code identifying a mapping code;
wherein the instruction code is embedded in an RFID tag.
